(19) United States
(12) Patent Application Publication
(10) Pub. No.: US 2024/0053638 A1
(43) Pub. Date: Feb. 15, 2024

(54) DISPLAY PANEL

(71) Applicant: TCL CHINA STAR OPTOELECTRONICS TECHNOLOGY CO., LTD., Shenzhen (CN)

(72) Inventor: Rentang Zhao, Shenzhen (CN)

(73) Assignee: TCL CHINA STAR OPTOELECTRONICS TECHNOLOGY CO., LTD., Shenzhen (CN)

(21) Appl. No.: 17/599,116

(22) PCT Filed: Aug. 13, 2021
(86) PCT No.: PCT/CN2021/112506

§ 371 Date: Sep. 28, 2021

(30) Foreign Application Priority Data
Jul. 22, 2021 (CN) 202110828305.1

(51) Int. Cl. G02F 1/1337; G02F 1/1343

(52) U.S. Cl. CPC G02F 1/133707; G02F 1/134309

(57) ABSTRACT

The present application relates to a display panel. By adjusting a width of a second branch electrode connected to a second trunk electrode parallel to an axis of curvature of the display panel, a width of an end of the second branch electrode close to the second trunk electrode is smaller than a width of an end of the second branch electrode away from the second trunk electrode.

### BACKGROUND OF INVENTION

### Field of Invention

The present application relates to a field of display technology, in particular to a display panel.

### Description of Prior Art

In thin film transistor liquid crystal displays (TFT-LCDs), polymer stabilized vertical alignment (PS-VA) has been adopted by more and more TV products due to its characteristics of high contrast and fast response times.

Products for different purposes have different performance requirements. For curved products, an array substrate and a color filter substrate may dislocate during a bending process of a display panel. Since sub-pixels of a pixel unit are divided into multiple liquid crystal domains, liquid crystal molecules in different liquid crystal domains have different tilting directions and different pretilt angles. When the array substrate or the color filter substrate dislocates when the panel is bent, a corresponding relationship in the liquid crystal domains between the array substrate and the color filter substrate is misaligned, and the liquid crystal molecules with different pretilt angles are aligned at a junction of the liquid crystal domains between the array substrate and the color filter substrate, resulting in a “fighting” phenomenon of the liquid crystal molecules, and dark lines appear at a middle of the sub-pixels of the pixel unit, leading to a phenomenon of dark clusters on a curved surface on the display panel macroscopically.

Therefore, there is a need to find a novel display panel to solve the above-mentioned problems.

### SUMMARY OF INVENTION

An object of the present application is to provide a display panel that can solve a problem of dark clusters on a curved surface in existing curved display panel.

In order to solve the above problems, the present application provides a display panel, including a plurality of pixel units arranged in an array, wherein each of the pixel units includes a first sub-pixel, and the first sub-pixel includes: a first trunk electrode perpendicular to an axis of curvature of the display panel; a second trunk electrode parallel to the axis of curvature of the display panel; and at least four first liquid crystal domains, wherein each of the first liquid crystal domains is provided with: a plurality of first branch electrodes arranged in parallel at intervals and connected to the first trunk electrode; and a plurality of second branch electrodes arranged in parallel at intervals and connected to the second trunk electrode, wherein a width of an end of each of the second branch electrodes close to the second trunk electrode is smaller than a width of an opposite end of each of the second branch electrodes away from the second trunk electrode.

Optionally, each of the second branch electrodes includes: a first sub-branch portion connected to the second trunk electrode; and a second sub-branch portion connected to an end of the first sub-branch portion away from the second trunk electrode, wherein a width of an opposite end of the first sub-branch portion close to the second trunk electrode is less than or equal to a width of the end of the first sub-branch portion away from the second trunk electrode.

Optionally, the width of the end of the first sub-branch portion away from the second trunk electrode is less than or equal to a width of an end of the second sub-branch portion close to the second trunk electrode.

Optionally, a shape of the first branch portion includes one or more of a rectangle, a stepped shape, an isosceles trapezoid, or a right-angled trapezoid.

Optionally, a length of the first sub-branch portion is in a range of 0-20 um.

Optionally, a width of each of the second branch electrodes is in a range of 0.1-6 um.

Optionally, a width of each of the first branch electrodes is in a range of 0.1-6 um.

Optionally, an intersection angle between the first branch electrodes and the first trunk electrode ranges from 30° to 60°.

Optionally, an intersection angle between the second branch electrodes and the second trunk electrode ranges from 30° to 60°.

Optionally, each of the pixel units further includes: a second sub-pixel disposed on one side of the first sub-pixel.

Optionally, the second sub-pixel includes: a third trunk electrode perpendicular to the axis of curvature of the display panel; a fourth trunk electrode parallel to the axis of curvature of the display panel; and at least four second liquid crystal domains, wherein each of the second liquid crystal domains is provided with: a plurality of third branch electrodes arranged in parallel at intervals and connected to the third trunk electrode; and a plurality of fourth branch electrodes arranged in parallel at intervals and connected to the fourth trunk electrode, wherein a width of an end of each of the fourth branch electrodes close to the fourth trunk electrode is smaller than a width of an opposite end of each of the fourth branch electrodes away from the fourth trunk electrode.

Optionally, each of the fourth branch electrodes includes: a third sub-branch portion connected to the fourth trunk electrode; and a fourth sub-branch portion connected to an end of the third sub-branch portion away from the fourth trunk electrode, wherein a width of an opposite end of the third sub-branch portion close to the fourth trunk electrode is less than or equal to a width of the end of the third sub-branch portion away from the fourth trunk electrode.

Optionally, the width of the end of the third sub-branch portion away from the fourth trunk electrode is less than or equal to a width of an end of the fourth sub-branch portion close to the fourth trunk electrode.

Optionally, a shape of the third branch portion includes one or more of a rectangle, a stepped shape, an isosceles trapezoid, or a right-angled trapezoid.

Optionally, a length of the third sub-branch portion is in a range of 0-20 um.

Optionally, a width of each of the fourth branch electrodes is in a range of 0.1-6 um.

Optionally, a width of each of the third branch electrodes is in a range of 0.1-6 um.

Optionally, an intersection angle between the third branch electrode and the third trunk electrode ranges from 30° to 60°.

Optionally, an intersection angle between the fourth branch electrode and the fourth trunk electrode ranges from 30° to 60°.

Optionally, the display panel further includes: an array substrate including a first substrate and the pixel units; a color filter substrate disposed opposite to the array substrate; and a liquid crystal layer disposed between the array substrate and the color filter substrate, wherein the pixel units are disposed between the first substrate and the liquid crystal layer.

The present application adjusts the width of the second branch electrode connected to the second trunk electrode parallel to the axis of curvature of the display panel, so that the width of the end of the second branch electrode close to the second trunk electrode is smaller than the width of the second branch electrode away from the second trunk electrode, thereby reducing an electric field of the end of the second branch electrode close to the second trunk electrode, thus further reducing a pretilt angle formed at the end of the second branch electrode close to the second trunk electrode, and then the pretilt angle on a side of a color filter substrate is simultaneously reduced, and finally a phenomenon of dark clusters on a curved surface is alleviated.

### BRIEF DESCRIPTION OF DRAWINGS

In order to more clearly illustrate technical solutions in embodiments of the present application, the following will briefly introduce drawings that need to be used in description of the embodiments.

FIG. 1 is a schematic structural diagram of an array substrate and a color filter substrate of a display panel that are not misaligned according to the present application.

FIG. 2 is a schematic diagram of an arrangement of pixel units on a first substrate according to the present application.

FIG. 3 is a schematic structural diagram of the display panel after being bent according to the present application.

FIG. 4 is a schematic diagram of a pixel unit of according to Embodiment 1 of the present application.

FIG. 5 is a partial enlarged view of a first sub-pixel of the pixel unit in FIG. 4.

FIG. 6 is a partial enlarged view of a second branch electrode of the first sub-pixel in FIG. 5.

FIG. 7 is a schematic diagram of a structure when the array substrate and the color filter substrate of the display panel are misaligned according to the present application.

FIG. 8 is a partial schematic diagram of the pixel unit of Embodiment 2 according to the present application.

FIG. 9 is a partial enlarged view of a second sub-pixel of the pixel unit in FIG. 8.

FIG. 10 is a partial enlarged view of a fourth branch electrode of the second sub-pixel in FIG. 9.

FIG. 11 is a schematic diagram of a pixel electrode layer according to Embodiment 3 of the present application.

FIG. 12 is a partial enlarged view of the second branch electrode of the first sub-pixel according to Embodiment 4 of the present application.

FIG. 13 is a partial enlarged view of the second branch electrode of the first sub-pixel according to Embodiment 5 of the present application.

FIG. 14 is a partial enlarged view of the second branch electrode of the first sub-pixel according to Embodiment 6 of the present application.

Elements in the drawings are designated by reference numerals listed below. 100. display panel; 200. axis of curvature
1. array substrate; 2. color filter substrate;
3. liquid crystal layer;
111. first substrate; 121. pixel unit;
1211. sub-pixel; 1212. thin film transistor;
1213. second sub-pixel;
10. first trunk electrode; 20. second trunk electrode;
30. first branch electrode; 40. second branch electrode;
50. third trunk electrode; 60. fourth trunk electrode;
70. third branch electrode; 80. fourth branch electrode;
401. first sub-branch portion; 402. second sub-branch portion;
801. third sub-branch portion; 802. fourth sub-branch portion.

### DETAILED DESCRIPTION OF PREFERRED EMBODIMENTS

The preferred embodiments of the present invention are described in detail below with reference to the accompanying drawings, in which FIG. Those skilled in the art will more readily understand how to implement the invention. The present invention may, however, be embodied in many different forms and embodiments, and the scope of the invention is not limited to the embodiments described herein.

The following description of the various embodiments is provided to illustrate the specific embodiments of the invention. The spatially relative directional terms mentioned in the present invention, such as “upper”, “lower”, “before”, “after”, “left”, “right”, “inside”, “outside”, “side”, etc. and the like, may be used herein for ease of description to describe one element or feature's relationship to another element(s) or feature(s) as illustrated in the figures which are merely references.

In the drawings, the spatially relative terms are intended to encompass different orientations in addition to the orientation as depicted in the figures. Moreover, the size and thickness of each component shown in the drawings are arbitrarily shown for ease of understanding and description, and the invention does not limit the size and thickness of each component.

### Embodiment 1

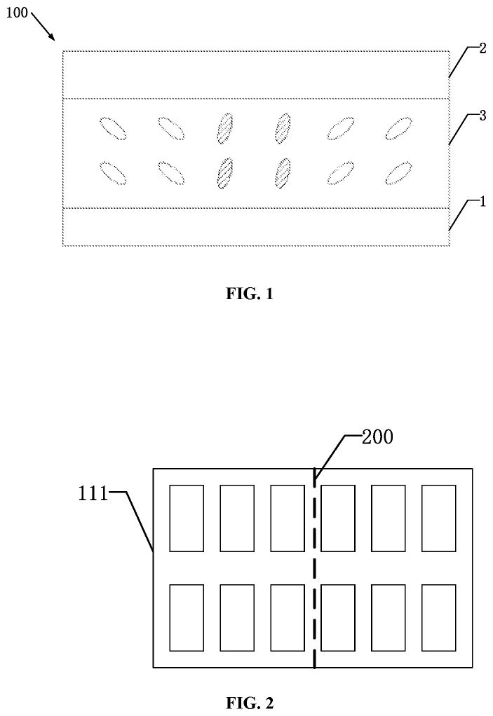

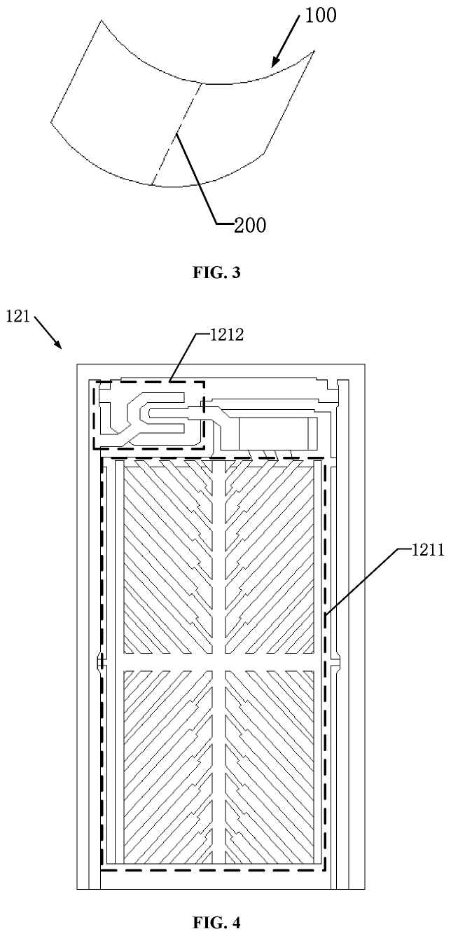

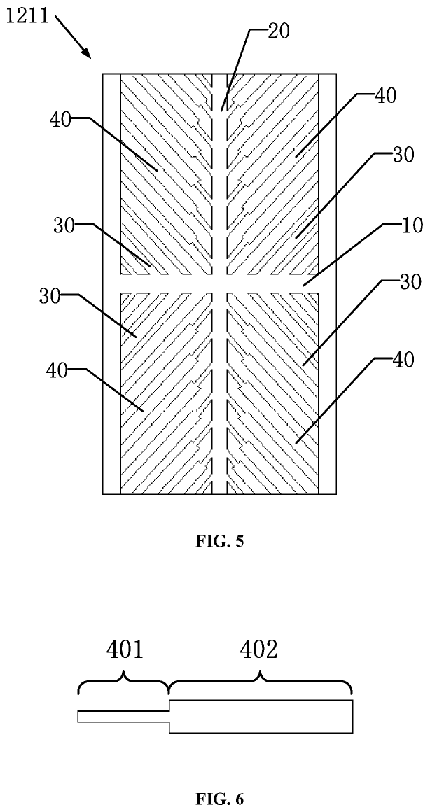

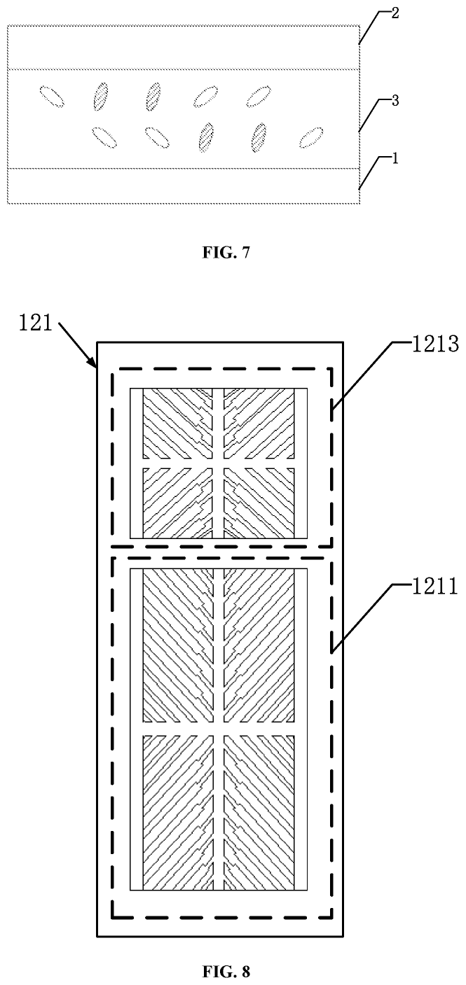

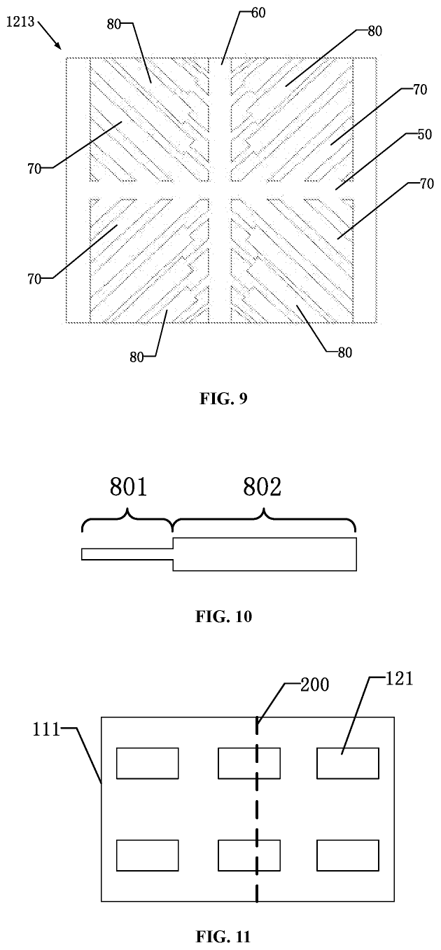

As shown in FIG. 1, this embodiment provides a display panel 100. The display panel 100 includes: an array substrate 1, a color filter substrate 2, and a liquid crystal layer 3. The color filter substrate 2 is disposed opposite to the array substrate 1, and the liquid crystal layer 3 is disposed between the array substrate 1 and the color filter substrate 2.

As shown in FIG. 2, the array substrate 1 includes a first substrate 111 and a plurality of pixel units 121. The pixel units 121 are arranged on a surface of the first substrate 111 facing the liquid crystal layer 3. A material of the first substrate 111 includes silicon dioxide, polyethylene, polypropylene, polystyrene, polylactic acid, polyethylene terephthalate, polyimide, or polyurethane. As such, the first substrate 111 can have a function of protecting the display panel 100 while improving bendability of the display panel 100.

As shown in FIGS. 2 to 5, each of the pixel units 121 includes a first sub-pixel 1211 and a thin film transistor 1212.

As shown in FIGS. 2 to 5, the first sub-pixel 1211 includes: a first trunk electrode 10 and a second trunk electrode 20. In this embodiment, a long side of the pixel units 121 is parallel to an axis of curvature 200 of the display panel 100. The first trunk electrode 10 is perpendicular to an axis of curvature 200 of the display panel 100, and the second trunk electrode 20 is parallel to the axis of curvature 200 of the display panel 100. That is, in this embodiment, the first trunk electrode 10 and the second trunk electrode 20 are perpendicular to each other.

The first sub-pixel includes at least four first liquid crystal domains. In this embodiment, the first trunk electrode 10 and the second trunk electrode 20 divide the first sub-pixel 1211 into the four first liquid crystal domains.

As shown in FIGS. 4 and 5, each of the first liquid crystal domains is provided with a plurality of first branch electrodes 30 and a plurality of second branch electrodes 40. A width of the second branch electrodes 40 is in a range of 0.1 to 6 um. The second branch electrodes 40 having the width greater than 6 um may cause abnormal alignment of liquid crystal molecules, thereby resulting in a decrease in transmittance of the display panel. The second branch electrode 40 having the width less than 0.1 um may greatly increase difficulty of a manufacturing process. A width of the first branch electrode 30 is in the range of 0.1 to 6 um. The first branch electrodes 30 having the width greater than 6 um may cause the abnormal alignment of the liquid crystal molecules, thereby resulting in the decrease in the transmittance of the display panel. The first branch electrodes 30 having the width less than 0.1 um may greatly increase the difficulty of the manufacturing process.

The plurality of first branch electrodes 30 are parallel to each other and arranged at intervals, and are connected to the first trunk electrode 10. An intersection angle between the first branch electrodes 30 and the first trunk electrode 10 ranges from 30° to 60°. Since when the intersection angle between the first branch electrodes 30 and the first trunk electrode 10 is 45°, the display panel has maximum transmittance, in this embodiment, the intersection angle between the first branch electrodes 30 and the first trunk electrodes 10 is 45°. In other embodiments, in order to improve viewing angles of the display panel, the intersection angle between the first branch electrodes 30 and the first trunk electrode 10 may also be 30° or 35°.

The plurality of second branch electrodes 40 are parallel to each other and arranged at intervals, and are connected to the second trunk electrode 20. An intersection angle between the second branch electrodes 40 and the second trunk electrode 20 ranges from 30° to 60°. Since when the intersection angle between the second branch electrodes 40 and the second trunk electrode 20 is 45°, the display panel has the maximum transmittance, in this embodiment, the intersection angle between the second branch electrodes 40 and the second trunk electrodes 20 is 45°. In other embodiments, in order to improve the viewing angles of the display panel, the intersection angle between the second branch electrodes 40 and the second trunk electrode 20 may also be 30° or 35°.

A width of an end of each second branch electrode 40 close to the second trunk electrode 20 is smaller than a width of an end of each second branch electrode away from the second trunk electrode 20.

By adjusting a width of each second branch electrode 40 connected to the second trunk electrode 20 parallel to a bending direction of the axis of curvature 200 of the display panel 100, the width of the end of each second branch electrode 40 close to the second trunk electrode 20 is smaller than the width of the end of each second branch electrode away from the second trunk electrode 20, thereby reducing an electric field of the end of each second branch electrode 40 close to the second trunk electrode 20, thus further reducing a pretilt angle formed at the end of each second branch electrode close to the second trunk electrode 20. That is, the pretilt angle near a middle of the second trunk electrode 20 in FIG. 5 is smaller than a pretilt angle away from an edge at the second trunk electrode 20. Then, a pretilt angle on a side of the color filter substrate 2 decreases simultaneously.

As shown in FIG. 7, when the display panel 100 is bent, the array substrate 1 and the color filter substrate 2 are misaligned. At this time, an area with a small pretilt angle on the side of the color filter substrate 2 corresponds to an area with a large pretilt angle on a side of the array substrate 1. The area with a small pretilt angle on the side of the array substrate 1 corresponds to an area with a large pretilt angle on the side of color filter substrate 2. Driven by an external electric field, the liquid crystal molecules will tilt in a direction along the pretilt angle. Because the liquid crystal molecules are polarized under the electric field, liquid crystal molecules with a small pretilt angle (a shadow filled ellipse in FIG. 7) will tilt following a tilting direction of liquid crystal molecules with a large pretilt angle (a hollow ellipse in FIG. 7), so that the liquid crystal molecules will not meet each other to cause a “fighting” phenomenon, thereby preventing dark lines and ultimately alleviating a phenomenon of dark clusters on a curved surface.

As shown in FIG. 6, each of the second branch electrodes 40 in this embodiment includes: a first sub-branch portion 401 and a second sub-branch portion 402. The first sub-branch portion 401 is connected to the second trunk electrode 20; the second sub-branch portion 402 is connected to an end of the first sub-branch portion 401 away from the second trunk electrode 20. A length of the first sub-branch portion 401 is in a range of 0 to 20 um. Preferably, in this embodiment, the length of the first sub-branch portion 401 is 10 um. In other embodiments, the length of the first sub-branch portion 401 may be 4 um, 8 um, 12 um, 20 um, and so on. A width of the second sub-branch portion 402 is uniform. In this embodiment, a ratio of a width of the first sub-branch portion 401 to the width of the second sub-branch portion 402 is less than ⅘. At this time, not only a pretilt angle at the first sub-branch portion 401 can be reduced, but also optical performance of the display panel 100 can be ensured by the second sub-branch portion 402.

A width of an end of the first sub-branch portion 401 close to the second trunk electrode 20 is less than or equal to a width of an end of the first sub-branch portion 401 away from the second trunk electrode 20. The width of the end of the first sub-branch portion 401 away from the second trunk electrode 20 is less than or equal to a width of an end of the second sub-branch portion 402 close to the second trunk electrode 20. In this embodiment, a shape of the first sub-branch portion 401 is rectangular. That is, in this embodiment, the width of the end of the first sub-branch portion 401 close to the second trunk electrode 20 is equal to the width of the end of the first sub-branch portion 401 away from the second trunk electrode 20. The width of the end of the first sub-branch portion 401 away from the second trunk electrode 20 is smaller than the width of the end of the second sub-branch portion 402 close to the second trunk electrode 20. Therefore, a width of an end of the second branch electrode 40 close to the second trunk electrode 20 is smaller than a width of an end away from the second trunk electrode 20, thereby reducing the electric field formed at the end of the second branch electrode 40 close to the second trunk electrode 20, thus further reducing a pretilt angle formed at the end of the second branch electrode 40 close to the second trunk electrode 20, and then a pretilt angle on the side of the color filter substrate 2 is simultaneously reduced. When the display panel 100 is bent, the array substrate 1 and the color filter substrate 2 are misaligned. At this time, the area with a small pretilt angle on the side of the color filter substrate 2 corresponds to the area with a large pretilt angle on the side of the array substrate 1. The area with the small pretilt angle on the side of the array substrate 1 corresponds to the area with the large pretilt angle on the side of color filter substrate 2. Driven by the external electric field, the liquid crystal molecules will tilt in a direction along the pretilt angle. Because the liquid crystal molecules are polarized under the electric field, the liquid crystal molecules with the small pretilt angle (the shadow filled ellipse in FIG. 7) will tilt following the tilting direction of the liquid crystal molecules with the large pretilt angle (the hollow ellipse in FIG. 7), so that the liquid crystal molecules will not meet each other to cause the “fighting” phenomenon, thereby preventing the dark lines and ultimately alleviating the phenomenon of the dark clusters on the curved surface.

The color filter substrate 2 includes other structures such as a color resist layer, a black matrix, a common electrode layer, etc., and details will not be described here for brevity.

### Embodiment 2

As shown in FIG. 8, this embodiment includes most of technical features of the Embodiment 1. A difference between this embodiment and the Embodiment 1 is that, in this embodiment, each pixel unit 121 further includes a second sub-pixel 1213. The second sub-pixel 1213 is arranged on one side of a first sub-pixel 1211.

As shown in FIG. 9, the second sub-pixel 1213 includes: a third trunk electrode 50 and a fourth trunk electrode 60. The third trunk electrode 50 is perpendicular to an axis of curvature 200 of a display panel 100; and the fourth trunk electrode 60 is parallel to the axis of curvature 200 of the display panel 100. That is, in this embodiment, the third trunk electrode 50 and the fourth trunk electrode 60 are perpendicular to each other.

The second sub-pixel 1213 includes at least four second liquid crystal domains. In this embodiment, the third trunk electrode 50 and the fourth trunk electrode 60 divide the second sub-pixel 1213 into four second liquid crystal domains.

As shown in FIGS. 8 and 9, each of the second liquid crystal domains is provided with a plurality of third branch electrodes 70 and a plurality of fourth branch electrodes 80. A width of the fourth branch electrodes 80 is in a range of 0.1 to 6 um. The fourth branch electrodes 80 having the width greater than 6 um may cause abnormal alignment of liquid crystal molecules, thereby resulting in a decrease in transmittance of the display panel; and the width of the fourth branch electrodes 80 that is less than 0.1 um may greatly increase difficulty of a manufacturing process. A width of the third branch electrodes 70 is in the range of 0.1 to 6 um. The third branch electrode 70 having the width greater than 6 um may cause the abnormal alignment of the liquid crystal molecules, thereby resulting in the decrease in the transmittance of the display panel; the width of the third branch electrode 70 that is less than 0.1 um may greatly increase the difficulty of the manufacturing process.

The plurality of third branch electrodes 70 are parallel to each other and arranged at intervals, and are connected to the third trunk electrode 50. An intersection angle between the third branch electrode 70 and the third trunk electrode 50 ranges from 30° to 60°. Since when the intersection angle between the third branch electrode 70 and the third trunk electrode 50 is 45°, the display panel has maximum transmittance, in this embodiment, the intersection angle between the third branch electrode 70 and the third trunk electrode 50 is 45°. In other embodiments, in order to improve viewing angles of the display panel, the intersection angle between the third branch electrode 70 and the third trunk electrode 50 may also be 30° or 35°.

The plurality of fourth branch electrodes 80 are parallel to each other and arranged at intervals, and are connected to the fourth trunk electrode 60. An intersection angle between the fourth branch electrode 80 and the fourth trunk electrode 60 ranges from 30° to 60°. Since when the intersection angle between the fourth branch electrode 80 and the fourth trunk electrode 60 is 45°, the display panel has the maximum transmittance, in this embodiment, the intersection angle between the fourth branch electrode 80 and the fourth trunk electrode 60 is 45°. In other embodiments, in order to improve the viewing angles of the display panel, the intersection angle between the fourth branch electrode 80 and the fourth trunk electrode 60 may also be 30° or 35°.

A width of an end of each fourth branch electrode 80 close to the fourth trunk electrode 60 is smaller than a width of an end of each fourth branch electrode 80 away from the fourth trunk electrode 60. By adjusting a width of the fourth branch electrodes 80 connected to the fourth trunk electrode 60 parallel to the axis of curvature 200 of the display panel 100, the width of the end of each fourth branch electrode 80 close to the fourth trunk electrode 60 is smaller than the width of the end of each fourth branch electrode away from the fourth trunk electrode 60, thereby reducing an electric field of the end of each fourth branch electrode 80 close to the fourth trunk electrode 60, thus further reducing a pretilt angle formed at the end of each fourth branch electrode 80 close to the fourth trunk electrode 60. That is, the pretilt angle near a middle of the fourth trunk electrode 60 in FIG. 9 is smaller than the pretilt angle away from an edge at the fourth trunk electrode 60. Then, a pretilt angle on the side of the color filter substrate 2 is simultaneously reduced. When the display panel 100 is bent, the array substrate 1 and the color filter substrate 2 are misaligned. At this time, an area with a small pretilt angle on the side of the color filter substrate 2 corresponds to an area with a large pretilt angle on a side of the array substrate 1. The area with a small pretilt angle on the side of the array substrate 1 corresponds to an area with a large pretilt angle on the side of color filter substrate 2. Driven by an external electric field, the liquid crystal molecules will tilt in a direction along the pretilt angle. Because the liquid crystal molecules are polarized under the electric field, liquid crystal molecules with a small pretilt angle (a shadow filled ellipse in FIG. 7) will tilt following a tilting direction of liquid crystal molecules with a large pretilt angle (a hollow ellipse in FIG. 7), so that the liquid crystal molecules will not meet each other to cause a “fighting” phenomenon, thereby preventing dark lines and ultimately alleviating phenomenon of dark clusters on a curved surface.

As shown in FIG. 10, each of the fourth branch electrodes 80 in this embodiment includes: a third sub-branch portion 801 and a fourth sub-branch portion 802. The third sub-branch portion 801 is connected to the fourth trunk electrode 60; and the fourth sub-branch portion 802 is connected to an end of the third sub-branch portion 801 away from the fourth trunk electrode 60. A length of the third sub-branch portion 801 is in a range of 0 to 20 um. Preferably, in this embodiment, the length of the third sub-branch portion 801 is 10 um. In other embodiments, the length of the third sub-branch portion 801 may be 4 um, 8 um, 12 um, 20 um, and so on. The width of the fourth sub-branch portion 802 is uniform. In this embodiment, a ratio of a width of the third sub-branch portion 801 to the width of the fourth sub-branch portion 802 is less than ⅘. At this time, not only a pretilt angle at the third sub-branch portion 801 can be reduced, but also optical performance of the display panel 100 can be ensured by the fourth sub-branch portion 802.

A width of an end of the third sub-branch portion 801 close to the fourth trunk electrode 60 is less than or equal to a width of an end of the third sub-branch portion 801 away from the fourth trunk electrode 60. The width of the end of the third sub-branch portion 801 away from the fourth trunk electrode 60 is less than or equal to a width of an end of the fourth sub-branch portion 802 close to the fourth trunk electrode 60. In this embodiment, a shape of the third sub-branch portion 801 is rectangular. That is, in this embodiment, a width of an end of the third sub-branch portion 801 close to the fourth trunk electrode 60 is equal to the width the end of the third sub-branch portion 801 away from the fourth trunk electrode 60. The width of the end of the third sub-branch portion 801 away from the fourth trunk electrode 60 is smaller than the width of the end of the fourth sub-branch portion 802 close to the fourth trunk electrode 60. As a result, the width of the end of the fourth branch electrode 80 close to the fourth trunk electrode 60 is smaller than a width of an end of the fourth branch electrode 80 away from the fourth trunk electrode 60, thereby reducing an electric field at the end of the fourth branch electrode 80 close to the fourth trunk electrode 60, thus further reducing a pretilt angle formed at the end of the fourth branch electrode 80 close to the fourth trunk electrode 60, and then the pretilt angle on the side of the color filter substrate 2 is simultaneously reduced. When the display panel 100 is bent, the array substrate 1 and the color filter substrate 2 are misaligned. At this time, the area with the small pretilt angle on the side of the color filter substrate 2 corresponds to the area with the large pretilt angle on a side of the array substrate 1. The area with the small pretilt angle on the side of the array substrate 1 corresponds to the area with the large pretilt angle on the side of color filter substrate 2. Driven by the external electric field, the liquid crystal molecules will tilt in a direction along the pretilt angle. Because the liquid crystal molecules are polarized under the electric field, the liquid crystal molecules with the small pretilt angle (the shadow filled ellipse in FIG. 7) will tilt following the tilting direction of the liquid crystal molecules with the large pretilt angle (the hollow ellipse in FIG. 7), so that the liquid crystal molecules will not meet with each other to cause the “fighting” phenomenon, thereby preventing the dark lines and ultimately alleviating the phenomenon of the dark clusters on the curved surface.

### Embodiment 3

As shown in FIG. 11, this embodiment includes most of the technical features of the Embodiment 1 or 2. A difference between this embodiment and the Embodiment 1 or 2 is that, in this embodiment, a short side of pixel units 121 is parallel to an axis of curvature 200 of a display panel 100. By adjusting a width of the second branch electrodes 40 connected to a second trunk electrode 20 parallel to the axis of curvature 200 of the display panel 100, a width of an end of the second branch electrodes 40 close to the second trunk electrode 20 is smaller than a width of an end of the second branch electrode 40 away from the second trunk electrode 20, thereby reducing an electric field of the end of the second branch electrode 40 close to the second trunk electrode 20, thus further reducing a pretilt angle formed at the end of the second branch electrode 40 close to the second trunk electrode 20, and then a pretilt angle on a side of a color filter substrate 2 is simultaneously reduced, and finally a phenomenon of dark clusters on a curved surface is alleviated.

### Embodiment 4

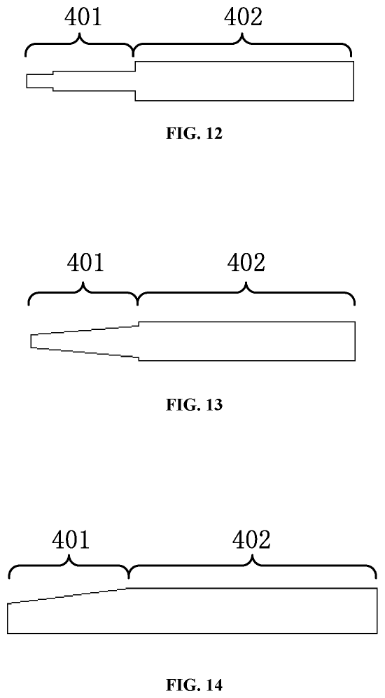

As shown in FIG. 12, this embodiment includes most of the technical features of any one of the Embodiments 1, 2, and 3. A difference between this embodiment and any one of the Embodiments 1, 2, and 3 is that, in this embodiment, a shape of a first sub-branch portion 401 is a stepped shape. That is, in this embodiment, a width of an end of the first sub-branch portion 401 close to a second trunk electrode 20 is smaller than a width of an end of the first sub-branch portion 401 away from the second trunk electrode 20. The width of the end of the first sub-branch portion 401 away from the second trunk electrode 20 is smaller than a width of an end of a second sub-branch portion 402 close to the second trunk electrode 20. Therefore, a width of an end of second branch electrodes 40 close to the second trunk electrode 20 is smaller than a width of an end of the second branch electrodes away from the second trunk electrode 20, thereby reducing an electric field of the end of the second branch electrodes 40 close to the second trunk electrode 20, thus further reducing a pretilt angle formed at the end of the second branch electrodes close to the second trunk electrode 20, then a pretilt angle on a side of a color filter substrate 2 is simultaneously reduced, and finally a phenomenon of dark clusters on a curved surface is alleviated.

### Embodiment 5

As shown in FIG. 13, this embodiment includes most of the technical features of any one of the Embodiments 1, 2, 3, and 4. A difference between this embodiment and any one of the Embodiments 1, 2, 3, and 4 is that, in this embodiment, a shape of a first sub-branch portion 401 is an isosceles trapezoid. That is, in this embodiment, a width of an end of the first sub-branch portion 401 close to a second trunk electrode 20 is smaller than a width of an end of the first sub-branch portion 401 away from the second trunk electrode 20. The width of the end of the first sub-branch portion 401 away from the second trunk electrode 20 is smaller than a width of an end of a second sub-branch portion 402 close to the second trunk electrode 20. Therefore, a width of an end of second branch electrodes 40 close to the second trunk electrode 20 is smaller than a width of an end of the second branch electrodes away from the second trunk electrode 20, thereby reducing an electric field of the end of the second branch electrode 40 close to the second trunk electrode 20, thus further reducing a pretilt angle formed at the end of the second branch electrodes close to the second trunk electrode 20, then a pretilt angle on a side of a color filter substrate 2 is simultaneously reduced, and finally a phenomenon of dark clusters on a curved surface is alleviated.

### Embodiment 6

As shown in FIG. 14, this embodiment includes most of the technical features of any one of the Embodiments 1, 2, 3, 4, and 5. A difference between this embodiment and any one of the Embodiments 1, 2, 3, 4, and 5 is that, in this embodiment, a shape of a first sub-branch portion 401 is a right-angled trapezoid. That is, in this embodiment, a width of an end of the first sub-branch portion 401 close to a second trunk electrode 20 is smaller than a width of an end of the first sub-branch portion 401 away from the second trunk electrode 20. The width of the end of the first sub-branch portion 401 away from the second trunk electrode 20 is equal to a width of an end of a second sub-branch portion 402 close to the second trunk electrode 20. Therefore, a width of an end of a second branch electrodes 40 close to the second trunk electrode 20 is smaller than the width of an end of the second branch electrodes away from the second trunk electrode 20, thereby reducing an electric field of the end of the second branch electrode 40 close to the second trunk electrode 20, thus further reducing a pretilt angle formed at the end of the second branch electrodes close to the second trunk electrode 20, then a pretilt angle on a side of a color filter substrate 2 is simultaneously reduced, and finally a phenomenon of dark clusters on a curved surface is alleviated.

The display panel provided by the embodiments of the present application is described in detail above. Specific embodiments are used to explain the principle and implementation of the present application. The descriptions of the above embodiments are only used to help understand the present application. Also, for those skilled in the art, according to the ideas of the present application, there will be changes in the specific implementation and application scope. In summary, the content of this specification should not be construed as limiting the present application.

What is claimed is:

1. A display panel, comprising a plurality of pixel units arranged in an array, wherein each of the pixel units comprises a first sub-pixel, and the first sub-pixel comprises:
a first trunk electrode perpendicular to an axis of curvature of the display panel;
a second trunk electrode parallel to the axis of curvature of the display panel; and
at least four first liquid crystal domains, wherein each of the first liquid crystal domains is provided with:
a plurality of first branch electrodes arranged in parallel and at intervals and connected to the first trunk electrode; and
a plurality of second branch electrodes arranged in parallel and at intervals and connected to the second trunk electrode,
wherein a width of an end of each of the second branch electrodes close to the second trunk electrode is smaller than a width of an end of each of the second branch electrodes away from the second trunk electrode.

2. The display panel according to claim 1, wherein each of the second branch electrodes comprises:
a first sub-branch portion connected to the second trunk electrode; and
a second sub-branch portion connected to an end of the first sub-branch portion away from the second trunk electrode,
wherein a width of an end of the first sub-branch portion close to the second trunk electrode is less than or equal to a width of the end of the first sub-branch portion away from the second trunk electrode.

3. The display panel according to claim 2, wherein the width of the end of the first sub-branch portion away from the second trunk electrode is less than or equal to a width of an end of the second sub-branch portion close to the second trunk electrode.

4. The display panel according to claim 2, wherein a shape of a first branch portion comprises one or more of a rectangle, a stepped shape, an isosceles trapezoid, or a right-angled trapezoid.

5. The display panel according to claim 2, wherein a length of the first sub-branch portion is in a range of 0 to 20 um.

6. The display panel according to claim 1, wherein a width of each of the second branch electrodes is in a range of 0.1 to 6 um.

7. The display panel according to claim 1, wherein a width of each of the first branch electrodes is in a range of 0.1 to 6 um.

8. The display panel according to claim 1, wherein an intersection angle between the first branch electrodes and the first trunk electrode ranges from 30° to 60°.

9. The display panel according to claim 1, wherein an intersection angle between the second branch electrodes and the second trunk electrode ranges from 30° to 60°.

10. The display panel according to claim 1, wherein each of the pixel units further comprises a second sub-pixel disposed on one side of the first sub-pixel.

11. The display panel according to claim 10, wherein the second sub-pixel comprises:
a third trunk electrode perpendicular to the axis of curvature of the display panel;
a fourth trunk electrode parallel to the axis of curvature of the display panel; and
at least four second liquid crystal domains, wherein each of the second liquid crystal domains is provided with:
a plurality of third branch electrodes arranged in parallel and at intervals and connected to the third trunk electrode; and
a plurality of fourth branch electrodes arranged in parallel and at intervals and connected to the fourth trunk electrode,
wherein a width of an end of each of the fourth branch electrodes close to the fourth trunk electrode is smaller than a width of an end of each of the fourth branch electrodes away from the fourth trunk electrode.

12. The display panel according to claim 11, wherein each of the fourth branch electrodes comprises:
a third sub-branch portion connected to the fourth trunk electrode; and
a fourth sub-branch portion connected to an end of the third sub-branch portion away from the fourth trunk electrode,
wherein a width of an end of the third sub-branch portion close to the fourth trunk electrode is less than or equal to a width of the end of the third sub-branch portion away from the fourth trunk electrode.

13. The display panel according to claim 12, wherein the width of the end of the third sub-branch portion away from the fourth trunk electrode is less than or equal to a width of an end of the fourth sub-branch portion close to the fourth trunk electrode.

14. The display panel according to claim 12, wherein a shape of a third branch portion comprises one or more of a rectangle, a stepped shape, an isosceles trapezoid, or a right-angled trapezoid.

15. The display panel according to claim 12, wherein a length of the third sub-branch portion is in a range of 0 to 20 um.

16. The display panel according to claim 11, wherein a width of each of the fourth branch electrodes is in a range of 0.1 to 6 um.

17. The display panel according to claim 1, wherein a width of each of the third branch electrodes is in a range of 0.1 to 6 um.

18. The display panel according to claim 11, wherein an intersection angle between the third branch electrodes and the third trunk electrode ranges from 30° to 60°.

19. The display panel according to claim 11, wherein an intersection angle between the fourth branch electrodes and the fourth trunk electrode ranges from 30° to 60°.

20. The display panel according to claim 1, further comprising:
an array substrate comprising a first substrate and the pixel units;
a color filter substrate disposed opposite to the array substrate; and
a liquid crystal layer disposed between the array substrate and the color filter substrate,
wherein the pixel units are disposed between the first substrate and the liquid crystal layer.
